(19) United States
(12) Patent Application Publication
(10) Pub. No.: US 2015/0012792 A1
(43) Pub. Date: Jan. 8, 2015

(54) METHOD AND APPARATUS FOR PROVIDING A TRANSMISSION CONTROL PROTOCOL MINIMUM RETRANSMISSION TIMER

(71) Applicant: TELEFONAKTIEBOLAGET L M ERICSSON (PUBL), Stockholm (SE)

(72) Inventors: Jakob Heitz, Santa Clara, CA (US); Charu Jain, Sunnyvale, CA (US); Chuan He, San Jose, CA (US)

(73) Assignee: TELEFONAKTIEBOLAGET L M ERICSSON (PUBL), Stockholm (SE)

(21) Appl. No.: 14/061,259

(22) Filed: Oct. 23, 2013

Related U.S. Application Data
(60) Provisional application No. 61/842,581, filed on Jul. 3, 2013.

(51) Int. Cl. H04L 1/18

(52) U.S. Cl. CPC H04L 1/188
USPC 714/748

(57) ABSTRACT

Disclosed is a method for reducing spurious retransmissions in a transmission control protocol (TCP) environment. An interval is established. A retransmission timeout (RTO) is set to remain constant during the interval. A maximum of all round trip time (RTT) measurements is used during the interval to set a new RTO for a next interval. An interval boundary is determined.

Also disclosed is an apparatus for reducing spurious retransmissions in a transmission control protocol (TCP) environment. The apparatus can include a processor. The processor can be configured to: establish an interval; set a retransmission timeout (RTO) to remain constant during the interval; use a maximum of all round trip time (RTT) measurements during the interval to set a new RTO for a next interval; and determine an interval boundary.

### CROSS-REFERENCES TO RELATED APPLICATIONS

This application claims priority to U.S. Provisional Application Ser. No. 61/842,581, filed on Jul. 3, 2013, the entire disclosure of which is hereby incorporated herein by reference in its entirety.

### FIELD

The present disclosure relates to transmission control protocol (TCP). More particularly, the present disclosure relates to round trip time (RTT) in a TCP environment.

### BACKGROUND

A TCP connection operating in an environment of highly variable RTT experiences many spurious retransmissions.

RFC 6298 describes an algorithm that computes a current retransmission timeout (RTO). In order to compute the current RTO, a TCP sender maintains two state variables, smoothed round trip time (SRTT) and round trip time variation (RTTVAR). Section 2.4 of RFC 6298 states that whenever RTO, e.g., retransmit timer, is computed, if less than 1 second, the RTO should be rounded up to 1 second.

The action to round up to 1 second has the undesirable effect of causing a sending device running TCP to wait longer to retransmit than needed. Most RTTs are less than 100 milliseconds. For example, a ping from a home in Santa Clara, Calif. to a server in Boston, Mass. can be around 92 mS. Additionally, a ping from Santa Clara, Calif. to distant Perth, Australia can be around 325 mS.

TCP code that runs in a virtual machine or in a thread in user-space outside of a kernel may experience several hundred milliseconds in which the TCP code does not run. One example of why the TCP code may not run is because the central processing unit (CPU) is busy running other threads. During the time that the code does run, RTTs may all be a few milliseconds. When the code gets another slice of runtime, some of the RTT measurements may be much longer. Several RTT measurements during the period of optimal thread runtime cause the RTT estimator to estimate a short RTT. When the kernel swaps the TCP thread out and begins to run a different thread, sessions that have a TCP packet in transit will experience a retransmission after the TCP thread is swapped back in again.

Any RTT estimator that considers short RTTs in its calculation will cause spurious retransmissions in this running environment. This occurs because there are many more short RTTs than long ones and the long RTTs are very much longer than the short RTTs.

Other algorithms for determining RTT estimates have been documented. These algorithms typically reduce the RTT estimate for every low RTT sample recorded. Some algorithms give higher weight to high samples than low ones, e.g., the Peak-Hopper-RTO algorithm. However, the Peak-Hopper-RTO algorithm does not adequately address the spurious retransmission problem for a TCP running in a thread.

Prior art algorithms use exponential smoothing algorithms to calculate RTO. However, smoothing algorithms do not work well in bursty or stochastic environments.

Therefore, there is a need in the art to solve the above described problems in order to minimize spurious retransmissions.

### SUMMARY

Disclosed is a method for reducing spurious retransmissions in a transmission control protocol (TCP) environment. In one embodiment, an interval is established. A retransmission timeout (RTO) is set to remain constant during the interval. A maximum of all round trip time (RTT) measurements is used during the interval to set a new RTO for a next interval. An interval boundary is determined.

Also disclosed is an apparatus for reducing spurious retransmissions in a transmission control protocol (TCP) environment. The apparatus can include a processor. The processor can be configured, in one embodiment, to: establish an interval; set a retransmission timeout (RTO) to remain constant during the interval; use a maximum of all round trip time (RTT) measurements during the interval to set a new RTO for a next interval; and determine an interval boundary.

The interval boundary can be determined when a RTT measurement of the interval is measured to be higher than a RTT used to determine an RTO for the interval.

The maximum of all RTT measurements for the interval can be set as the new RTO for the next interval.

The maximum of all RTT measurements for the interval can be used to calculate the new RTO for the next interval.

The interval boundary can be determined once a certain amount of data has been transmitted into a connection.

The interval boundary can be defined as an end of the interval or a beginning of the next interval.

TCP may be run on a plurality of network elements. The plurality of network elements can include one or more of physical network elements and virtual machines running TCP.

A determination can be made as to when a spurious transmission is acceptable. The acceptability of the spurious retransmission can be determined according to a packet retransmission rate threshold.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to affect such feature, structure, or characteristic in connection with other embodiments whether or not explicitly described.

FIG. 1 illustrates an example flow diagram showing a RTO period according to one embodiment.

FIG. 2 illustrates an example flow diagram showing a RTO period according to one embodiment.

FIG. 3 illustrates a method for reducing spurious retransmissions in a TCP environment according to one embodiment.

FIG. 4 illustrates a graph showing RTT measurements and intervals according to one embodiment.

FIG. 5 illustrates an example network element according to one embodiment.

### DESCRIPTION OF EMBODIMENTS

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art that the invention may be practiced without such specific details. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

As used herein, a network element (e.g., a router, switch, bridge) is a piece of networking equipment, including hardware and software that communicatively interconnects other equipment on the network (e.g., other network elements, end stations). Some network elements are “multiple services network elements” that provide support for multiple networking functions (e.g., routing, bridging, switching, Layer 2 aggregation, session border control, Quality of Service, and/or subscriber management), and/or provide support for multiple application services (e.g., data, voice, and video). Subscriber end stations (e.g., servers, workstations, laptops, netbooks, palm tops, mobile phones, smartphones, multimedia phones, Voice Over Internet Protocol (VOIP) phones, user equipment, terminals, portable media players, tablets, GPS units, gaming systems, set-top boxes) access content/services provided over the Internet and/or content/services provided on virtual private networks (VPNs) overlaid on (e.g., tunneled through) the Internet. The content and/or services are typically provided by one or more end stations (e.g., server end stations) belonging to a service or content provider or end stations participating in a peer to peer service, and may include, for example, public webpages (e.g., free content, store fronts, search services), private webpages (e.g., username/password accessed webpages providing email services), and/or corporate networks over VPNs. Typically, subscriber end stations are coupled (e.g., through customer premise equipment coupled to an access network (wired or wirelessly)) to edge network elements, which are coupled (e.g., through one or more core network elements) to other edge network elements, which are coupled to other end stations (e.g., server end stations).

Different embodiments of the invention may be implemented using different combinations of software, firmware, and/or hardware. Thus, the techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device.

In an environment where the high spikes in RTT measurements are an order of magnitude higher than the regular measurements and the number of high spikes are an order of magnitude less, any RTT estimator that reduces its estimate as a response to receiving an RTT measurement will cause a spurious retransmit when the spike occurs. This environment is seen, for example, when TCP is operating in a thread in a performance stressed router.

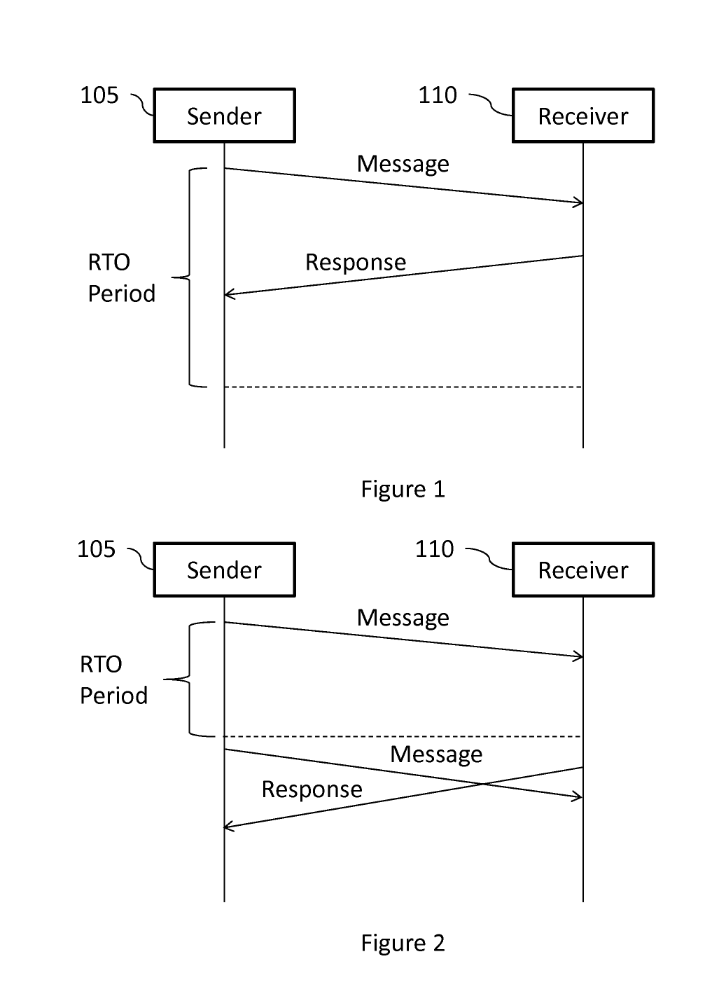

FIG. 1 illustrates an example flow diagram showing a RTO period. A message, e.g., control messages, data, or any other packetized information, is sent from a sender 105 to a receiver 110 over a TCP-based network connection. Sender 105 and receiver 110 can be network elements as defined above communicating over the TCP-based network connection. Typically, when the receiver 110 receives the message from the sender 105, a response, e.g., an acknowledgement (ACK), can be sent back to the sender 105 by the receiver 110. In this case, the response is received well within the selected RTO period.

FIG. 2 illustrates an example flow diagram showing a RTO period. Sender 105 sends a message to receiver 110. However, in this scenario, a response from the receiver 110 has not been received by the sender 105 before the expiration of the RTO period. The expiration of the RTO period prompts a spurious retransmission.

There can be various causes for spurious retransmissions. One such cause can be attributed to the inability of the receiver 110 to send an ACK to the sender because the TCP stack runs in a user space of the network element, e.g., receiver 110. This user space runs in a thread that is not always running. When the thread is not running, a delay can be introduced to the RTT variable as measured by the sender 105 because the receiver 110 can receive a packet from sender 105 but will not be able to send a response to the sender 105. In addition, if this delay is too long, a spurious retransmission from the sender 105 to the receiver 110 will occur because an ACK has not been received from receiver 110 prior to the commencement of the RTO period.

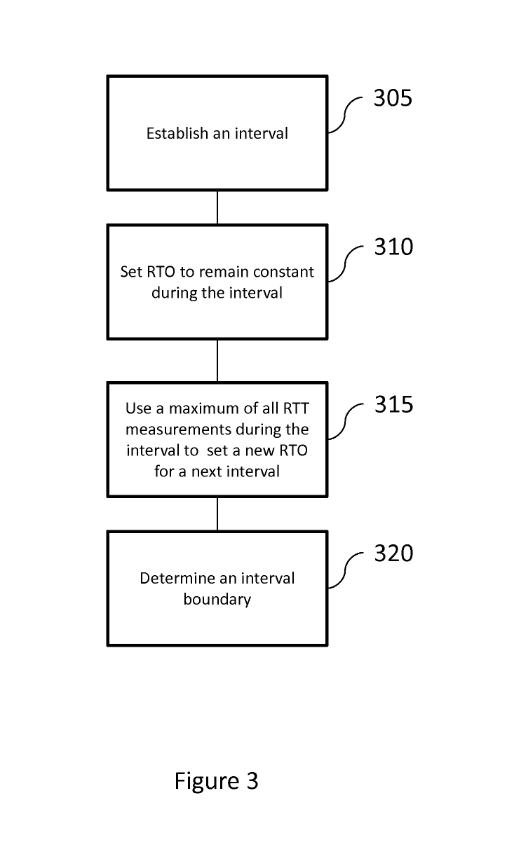

FIG. 3 illustrates a method for reducing spurious retransmissions in a TCP environment according to one embodiment. At block 305, an interval is established. In one embodiment, the initial RTO is set to 1 second. In another embodiment, an exponential smoothing algorithm, e.g., as defined in RFC 6298, is used to set the RTO for the first interval.

At block 310, the RTO is set to remain constant during the interval. At block 315, a maximum of all RTT measurements during the interval is used to set a new RTO for a next interval. In one embodiment, the RTO is set to 1.25 times the highest measured RTT. In another embodiment, the RTO can be set using a high-biased exponential smoothing algorithm.

At block 320, an interval boundary is determined. The interval boundary, e.g., the end of an interval or the beginning of the next interval, is determined when either: 1. A RTT is measured to be higher than the RTT used to determine the RTO for the current interval; or 2. TCP has transmitted a certain amount of data into the connection. In one embodiment, the RTO of a present interval is set to a value of a maximum RTT of the previous interval.

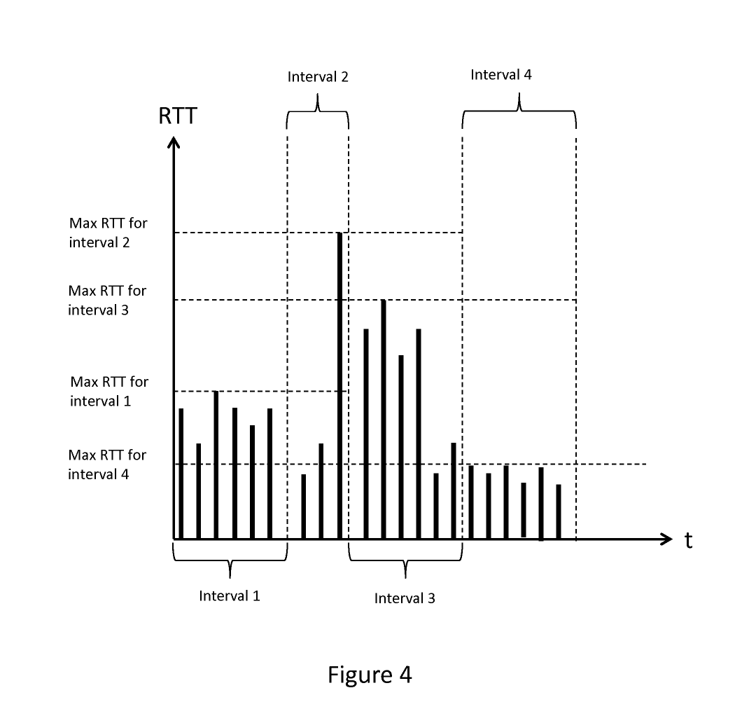

FIG. 4 illustrates a graph showing RTT measurements and intervals according to one embodiment. RTT data is collected for interval 1. Here the interval boundary, e.g., the end of the first interval or the beginning of the second interval, occurs after a certain amount of TCP data has been transmitted into the connection, e.g., the connection between network elements 105, 110. A maximum RTT for interval 1 is used to determine the RTO period for interval 2. In interval 2, the maximum RTT value exceeds the maximum RTT value for interval 1. As such, the interval boundary for interval 2 occurs before a certain set amount of data has been transmitted into the connection. RTT data collection continues in interval 3. Because the maximum RTT value in interval 3 does not exceed the maximum RTT value from interval 2, the interval boundary for interval 3 occurs after a certain amount of TCP data has been transmitted into the connection. Likewise, because the maximum RTT value in interval 4 does not exceed the maximum RTT value from interval 3, the boundary for interval 4 is based on the amount of data transmitted into the connection.

High RTTs cause spurious retransmits, not low RTTs. Therefore, the present disclosure considers high RTT measurements. Of course, if an RTT estimator only ever used the highest measured RTT and the network conditions improve, the RTT estimator would never reduce the estimate to track the improved network conditions. However the risk of a spurious retransmission is increased if the RTT estimator decreases its estimate. In one embodiment, a determination is made as to when a spurious transmission is acceptable, e.g., according to a packet retransmission rate threshold. Whenever a retransmission occurs, a maximum of a full window is retransmitted. In one embodiment, one in 20 to 50 packets can be retransmissions. Therefore, in this embodiment, the RTT estimate is not reduced until 20 to 50 maximum windows of data have been transmitted.

One advantage of the present disclosure is that spurious retransmissions are reduced in an environment of highly variable RTT. Also, the RTT is not constrained by any minimum value. Thus, for example, if the RTT is never more than 1 millisecond, then the RTT estimator will use 1 millisecond to determine the RTO period and not the RFC 6298 mandated minimum of 1 second.

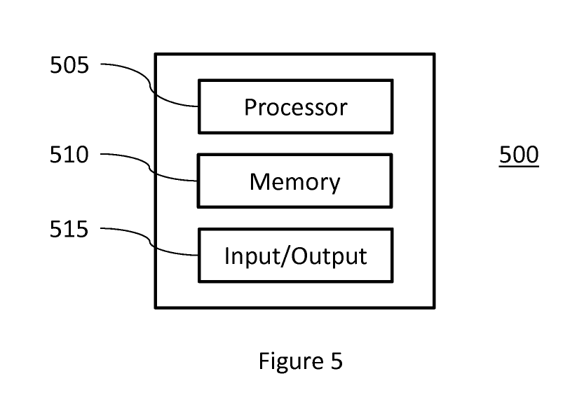

FIG. 5 illustrates an example network element. Network element 105, 110, 500 comprises a processor (CPU) 505, a memory 510, e.g., random access memory (RAM) and/or read only memory (ROM), and various input/output devices 515, (e.g., storage devices, including but not limited to, a tape drive, a floppy drive, a hard disk drive or a compact disk drive, a receiver, a transmitter). Network element 500 is capable of implementing methods for reducing spurious transmissions in a TCP environment. The method can be implemented directly by a physical network element. In addition, the method can be implemented using TCP code running in a virtual machine on a network element.

The processes described above, including but not limited to those presented in connection with FIGS. 1-4, may be implemented in general, multi-purpose or single purpose processors. Such a processor, e.g., processor 505, will execute instructions, either at the assembly, compiled or machine-level, to perform that process. Those instructions can be written by one of ordinary skill in the art following the description of presented above and stored or transmitted on a computer readable medium, e.g., a non-transitory computer-readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

While the invention has been described in terms of several embodiments, those skilled in the art will recognize that the invention is not limited to the embodiments described. The description is thus to be regarded as illustrative instead of limiting.

What is claimed is:

1. A method for reducing spurious retransmissions in a transmission control protocol (TCP) environment, which comprises:
establishing an interval;
setting a retransmission timeout (RTO) to remain constant during the interval;
using a maximum of all round trip time (RTT) measurements during the interval to set a new RTO for a next interval; and
determining an interval boundary.

2. The method of claim 1, wherein the interval boundary is determined when a RTT measurement of the interval is measured to be higher than a RTT used to determine an RTO for the interval.

3. The method of claim 1, wherein the maximum of all RTT measurements for the interval is set as the new RTO for the next interval.

4. The method of claim 1, wherein the maximum of all RTT measurements for the interval is used to calculate the new RTO for the next interval.

5. The method of claim 1, wherein the interval boundary is determined once a certain amount of data has been transmitted into a connection.

6. The method of claim 1, wherein the interval boundary is defined as an end of the interval or a beginning of the next interval.

7. The method of claim 1, wherein TCP is run on a plurality of network elements.

8. The method of claim 7, wherein the plurality of network elements comprise one or more of physical network elements and virtual machines running TCP .

9. The method of claim 1, which further comprises determining when a spurious transmission is acceptable.

10. The method of claim 9, wherein the acceptability of the spurious retransmission is determined according to a packet retransmission rate threshold.

11. An apparatus for reducing spurious retransmissions in a transmission control protocol (TCP) environment, the apparatus comprising:
a processor configured to:
establish an interval;
set a retransmission timeout (RTO) to remain constant during the interval;
use a maximum of all round trip time (RTT) measurements during the interval to set a new RTO for a next interval; and
determine an interval boundary.

12. The apparatus of claim 11, wherein the interval boundary is determined when a RTT measurement of the interval is measured to be higher than a RTT used to determine an RTO for the interval.

13. The apparatus of claim 11, wherein the maximum of all RTT measurements for the interval is set as the new RTO for the next interval.

14. The apparatus of claim 11, wherein the maximum of all RTT measurements for the interval is used to calculate the new RTO for the next interval.

15. The apparatus of claim 11, wherein the interval boundary is determined once a certain amount of data has been transmitted into a connection.

16. The apparatus of claim 11, wherein the interval boundary is defined as an end of the interval or a beginning of the next interval.

17. The apparatus of claim 11, wherein TCP is run on a plurality of network elements.

18. The apparatus of claim 17, wherein the plurality of network elements comprise one or more of physical network elements and virtual machines running TCP.

19. The apparatus of claim 11, which further comprises determining when a spurious transmission is acceptable.

20. The apparatus of claim 19, wherein the acceptability of the spurious retransmission is determined according to a packet retransmission rate threshold.
